(19) United States
(12) Patent Application Publication
(10) Pub. No.: US 2014/0090861 A1
(43) Pub. Date: Apr. 3, 2014

(54) Pneumatic Tool Having a Two-Stage Trigger Device

(71) Applicant: Basso Industry Corp., Taichung (TW)

(72) Inventor: Chiang Hua, Taichung (TW)

(73) Assignee: BASSO INDUSTRY CORP., Taichung (TW)

(21) Appl. No.: 14/038,742

(22) Filed: Sep. 26, 2013

(30) Foreign Application Priority Data
Oct. 1, 2012 (TW) 101136227

(51) Int. Cl. B25F 5/00

(52) U.S. Cl. CPC B25F 5/00
USPC 173/169

(57) ABSTRACT

A two-stage trigger device includes a trigger mounted on a body. Upon application of an external force, the trigger is rotated from a first position to a second position to move a rod member along an axis by a first distance, so as to open a passage to a predetermined degree. When the trigger reaches the second position, and when application of the external force is continued, at least one portion of the trigger moves in the body to move the rod member along the axis by a second distance, such that the opening degree of the passage is increased gradually.

### CROSS-REFERENCE TO RELATED APPLICATION

This application claims priority of Taiwanese Application No. 101136227, filed on Oct. 1, 2012.

### BACKGROUND OF THE INVENTION

1. Field of the Invention

This invention relates to a pneumatic tool, and more particularly to a pneumatic tool having a two-stage trigger device.

2. Description of the Related Art

Referring to FIGS. 1 and 2, a pneumatic tool disclosed in Taiwanese Patent Publication No. M396733 includes a body 11, a passage 12 formed in the body 11 for guiding entry of a gas, a switch valve 13 extending through the passage 12 along an axis (X), and a trigger 14 disposed movably on the body 11. The switch valve 13 includes a pin 131 connected co-rotatably to the trigger 14, and a gas blocking member 132 disposed on the pin 131 for sealing an end of the passage 12.

Upon application of an external force to the trigger 14, the trigger 14 moves along the axis (X) so that the pin 131 activates the gas blocking member 132 to open the passage 12, thereby ending a first-stage movement of the pin 131. Subsequently, when movement of the pin 131 is continued, i.e., a second-stage movement of the pin 131 occurs, the opening degree of the passage 12 is increased gradually. By such a two-stage movement, the flow rate of the passage can be controlled.

However, since the gas blocking member 132 is disposed on the pin 131, and since the pin 131 is co-rotatable with the trigger 14, the pressure of the gas flowing in the passage 12 forms a resistance to movement of the pin 131 and the trigger 14, thereby resulting in difficulties in actuation of the trigger 14. As such, to open the passage 12, it is necessary to apply a comparatively large force to the trigger 14, thereby resulting in difficulties in controlling the second-stage movement of the pin 131.

Referring to FIG. 3, another conventional pneumatic tool 2 includes a body 21, and a trigger 22 that is rotatable to perform a non-stage gas flow control. Since the trigger 22 is mounted swingably on the body 21, it is easy to actuate. However, since the swinging movement of the trigger 22 is converted into a straight movement of another element, the trigger 22 needs to be rotated by a relatively large angle. Furthermore, in this manner, the gas flow rate is difficult to control, and a finger maybe clamped between the trigger 22 and the body 21.

### SUMMARY OF THE INVENTION

The object of this invention is to provide a two-stage gas flow control for a pneumatic tool, which can control the gas flow rate in an easy and more accurate manner and which can be operated smoothly.

According to this invention, a pneumatic tool has a two-stage trigger device that includes a trigger mounted on a body. Upon application of an external force, the trigger is rotated from a first position to a second position to move a rod member along an axis by a first distance, so as to open a passage to a predetermined degree. When the trigger reaches the second position, and when application of the external force is continued, at least one portion of the trigger moves in the body to drive movement of the rod member along the axis by a second distance, such that the opening degree of the passage is increased gradually.

As such, through conversion between the rotation of the trigger and the movement of the at least one portion of the trigger, entry of the trigger device into the second stage can be realized so that the gas flow rate can be controlled easily and accurately.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 a sectional view of a conventional pneumatic tool disclosed in Taiwanese Patent Publication NO. M396733, having a movable trigger, illustrating that a gas passage is closed;

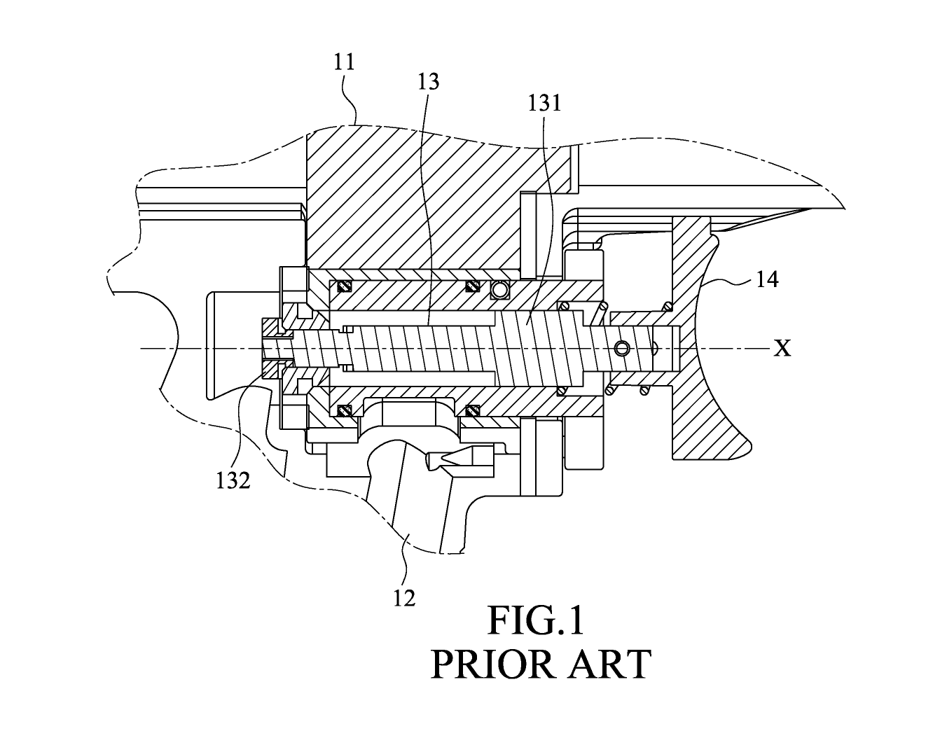

FIG. 2 is a view similar to FIG. 1 but illustrating that the gas passage is opened;

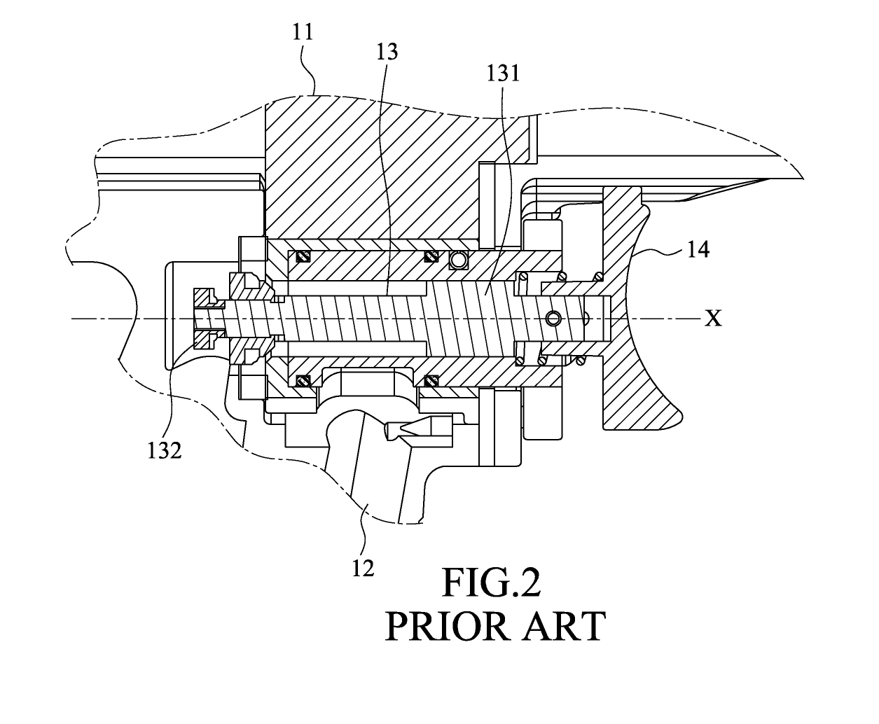

FIG. 3 is a side view of another conventional pneumatic tool having a pivotable trigger;

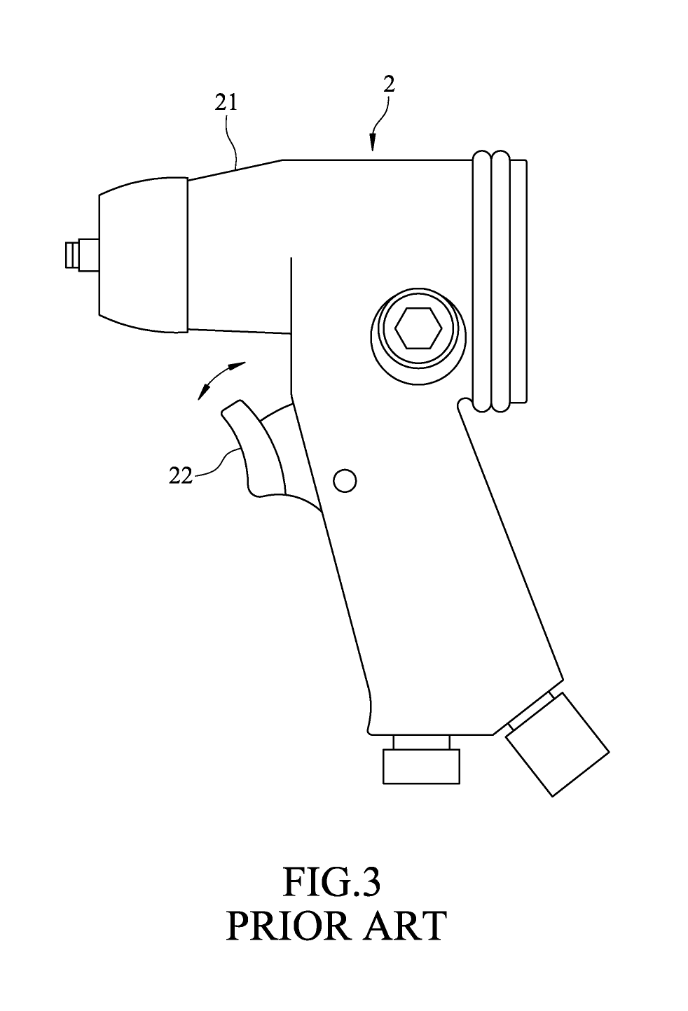

FIG. 4 is a sectional view of the second preferred embodiment of a pneumatic tool according to this invention, illustrating that a trigger is not actuated;

FIG. 5 is an exploded perspective view of a trigger of the first preferred embodiment;

FIG. 6 is a view similar to FIG. 4 but illustrating a first stage of a trigger device;

FIG. 7 is a view similar to FIG. 4 but illustrating a second stage of the trigger device;

FIG. 8 is an exploded perspective view of a trigger of the second preferred embodiment of a pneumatic tool according to this invention;

FIG. 9 is a sectional view of the second preferred embodiment, illustrating a first stage of a trigger device;

FIG. 10 is a view similar to FIG. 9 but illustrating a second stage of the trigger device of the second preferred embodiment;

FIG. 11 is a sectional view of the third preferred embodiment of a pneumatic tool according to this invention, illustrating a first stage of a trigger;

FIG. 12 is a view similar to FIG. 11 but illustrating a second stage of the trigger device;

FIG. 13 is a sectional view of the fourth preferred embodiment of a pneumatic tool according to this invention, illustrating a first stage of a trigger device;

FIG. 14 is a view similar to FIG. 13 but illustrating a second stage of the trigger device;

FIG. 15 is a sectional view of the fifth preferred embodiment of a pneumatic tool according to this invention, illustrating a first stage of a trigger device;

FIG. 16 is a view similar to FIG. 15 but illustrating a second stage of the trigger device;

FIG. 17 is a sectional view of the sixth preferred embodiment of a pneumatic tool according to this invention, illustrating a first stage of a trigger device; and

FIG. 18 is a view similar to FIG. 17 but illustrating a second stage of the trigger device.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

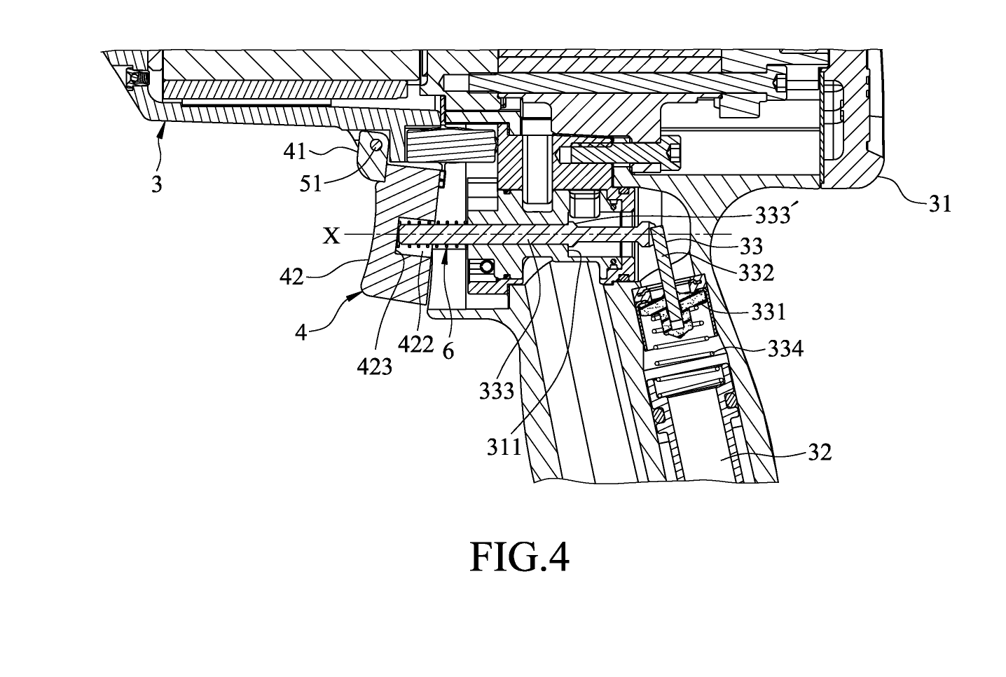

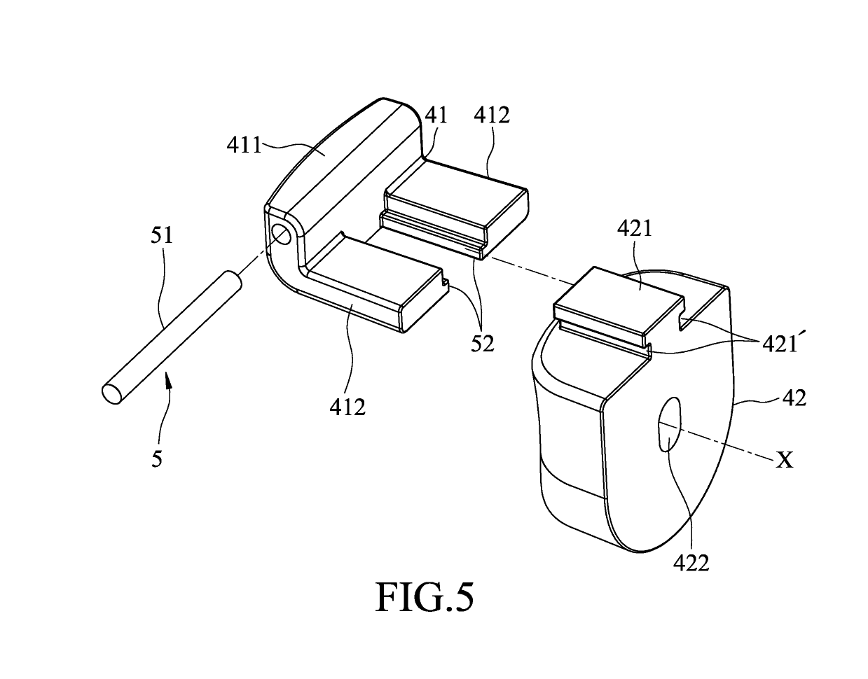

Referring to FIGS. 4 and 5, the first preferred embodiment of a pneumatic tool 3 according to this invention includes a body 31, a passage 32 formed in the body 31 for guiding entry of a gas, a switch valve 33, and a two-stage trigger device. The switch valve 33 includes a plug 331 for sealing the passage 32, a plug rod 332 connected to the plug 331, a rod member 333 extending in the body 31 along an axis (X) and abutting against the plug rod 332, and a first resilient member 334 disposed between the body 31 and the plug 331 for biasing the plug 331 to seal the passage 32. The second trigger device includes a trigger 4, a motion conversion unit 5, and a second resilient member 6.

The trigger 4 includes a first plate 41 and a second plate 42. The first plate 41 has a connecting portion 411 adjacent to an end thereof, and two swinging portions 412 adjacent to an opposite end thereof and spaced apart from each other. The second plate 42 has a T-shaped projection 421 defining two slide slots 421′ formed respectively in two opposite sides thereof, and a blind hole 422 defined by a bottom wall surface 423.

The motion conversion unit 5 includes a pin 51 and two aligned tracks 52. The pin 51 extends through the connecting portion 411 of the first plate 41 for connecting the first plate 41 pivotally to the body 31. The tracks 52 are disposed respectively on the swinging portions 412 of the first plate 41. In this embodiment, the tracks 52 are configured as two spaced-apart ribs extending respectively from the swing portions 412 toward each other. The tracks 52 engage respectively and movably the slide slots 421′.

The second resilient member 6 is disposed between the body 31 and the swinging portions 412 of the trigger 4, and cooperates with the first resilient member 334 so as to bias an end of the plug rod 332 and an end of the rod member 333 to press against each other, and so as to bias a flange 333′ of the rod member 333 to contact a positioning surface 311 of the body 31. Hence, the trigger 4 is disposed at a first position shown in FIG. 4 whereat the second plate 42 projects outwardly from the body 31.

It should be noted that, the second resilient member 6 is disposed only for facilitating outward projection of the second plate 42. In other words, by the biasing action of only the first resilient member 334, the second plate 42 can be biased to project outwardly from the body 31, the passage 32 can be sealed, and the rod member 333 can be pressed against the bottom wall surface 423 of the second plate 42, so as to maintain the first position of the trigger 4.

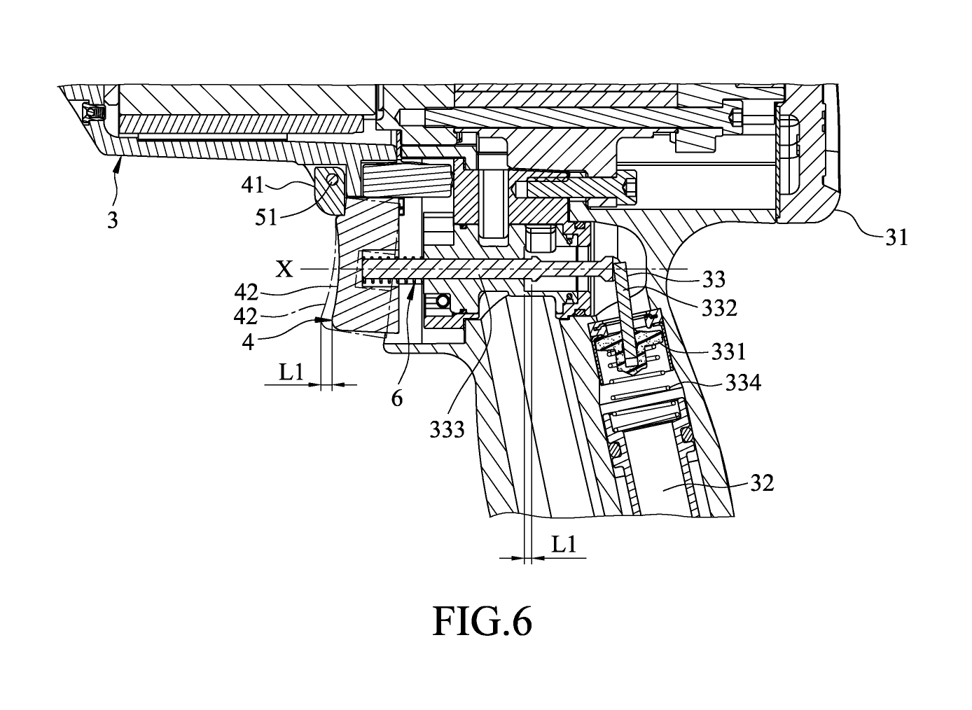

With particular reference to FIG. 6, at the first stage, an external force is applied to the second plate 42 to overcome the biasing forces of the first and second resilient members 334, 6, so as to rotate the first and second plates 41, 42 counterclockwise about the pin 51 until the swinging portions 412 of the first plate 41 come into contact with an inner surface of the body 31 that is parallel to the axis (X), such that the rod member 333 is driven by the second plate 42 to move along the axis (X) by a first distance (L1) to thereby move the plug rod 332 and the plug 331 to open the passage 32 to a predetermined degree. At this time, the first stage is ended, and the trigger 4 is disposed at a second position.

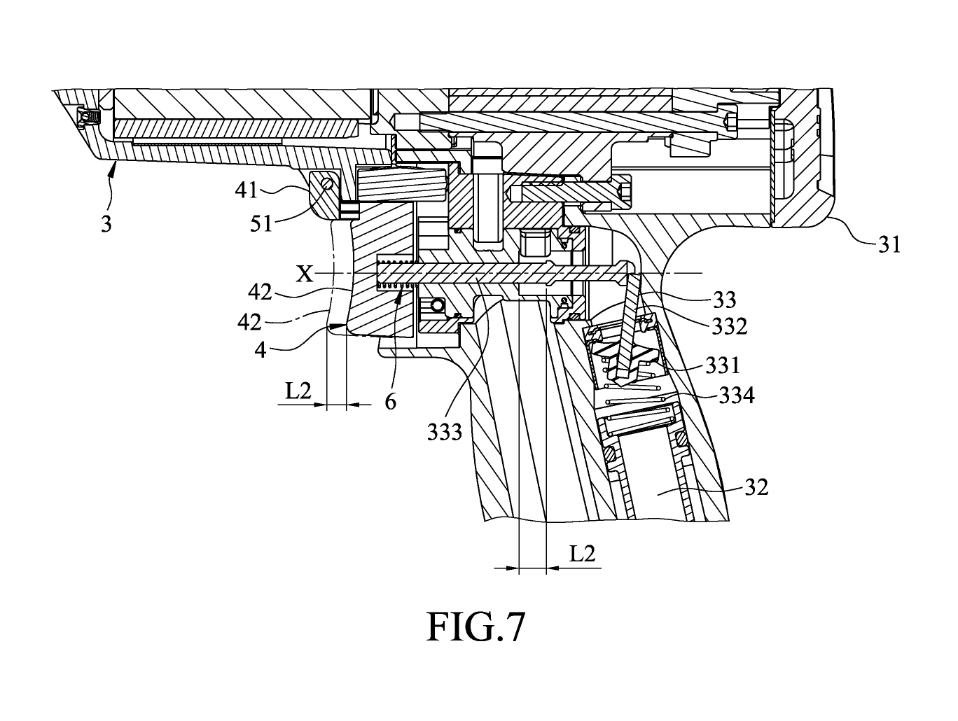

With particular reference to FIG. 7, at the second stage, application of the external force is continued. At this time, since further counterclockwise rotation of the trigger 4 is prevented, the second plate 42 moves relative to the first plate 41 along the tracks 52 in a direction parallel to the axis (X). Hence, the rod member 333 is pushed by the second plate 42 to move along the axis (X) by a second distance (L2), such that the opening degree of the passage 32 is increased gradually. Since the trigger 4 can move the rod member 333, additional members are not required to convert the rotation of the trigger 4 into the linear movement of the rod member 333, so that the distance travelled by the rod member 333 can be reduced significantly.

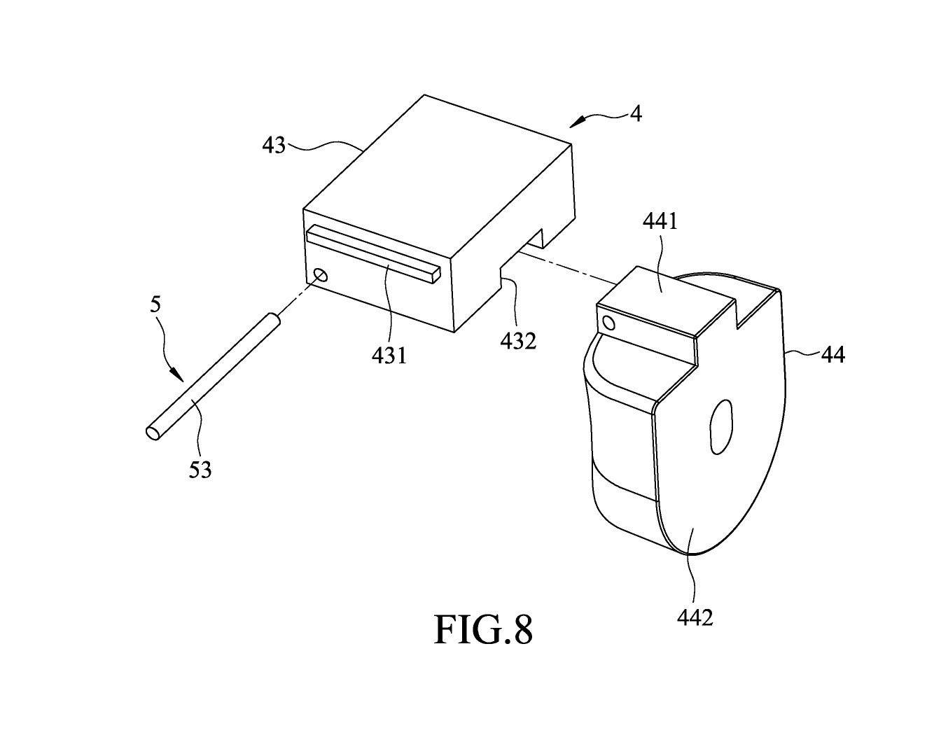

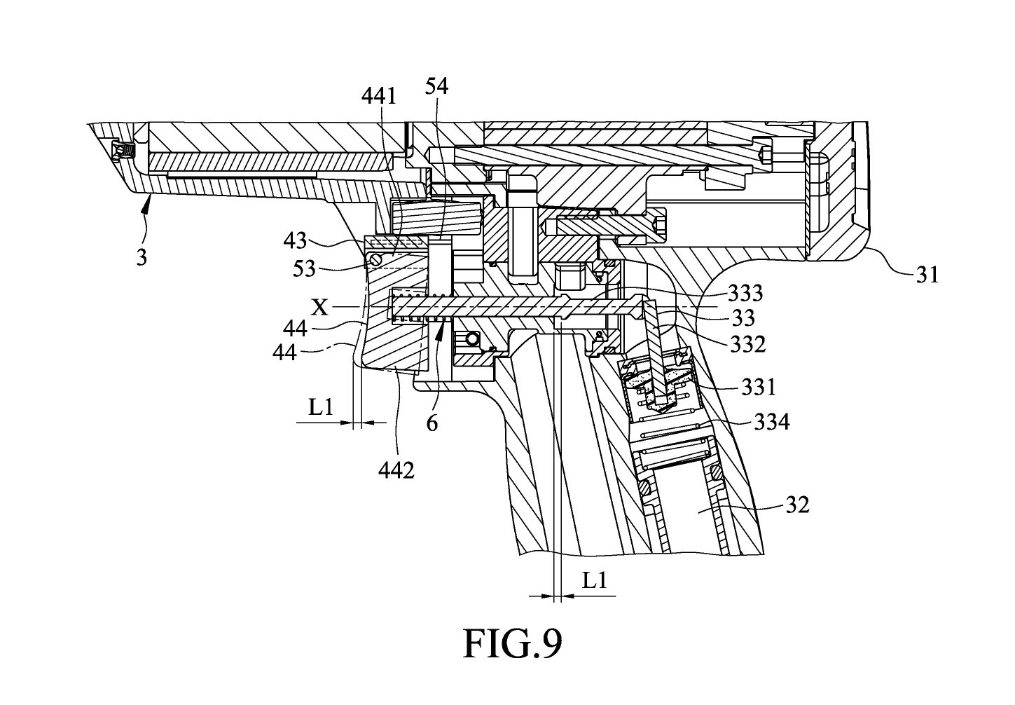

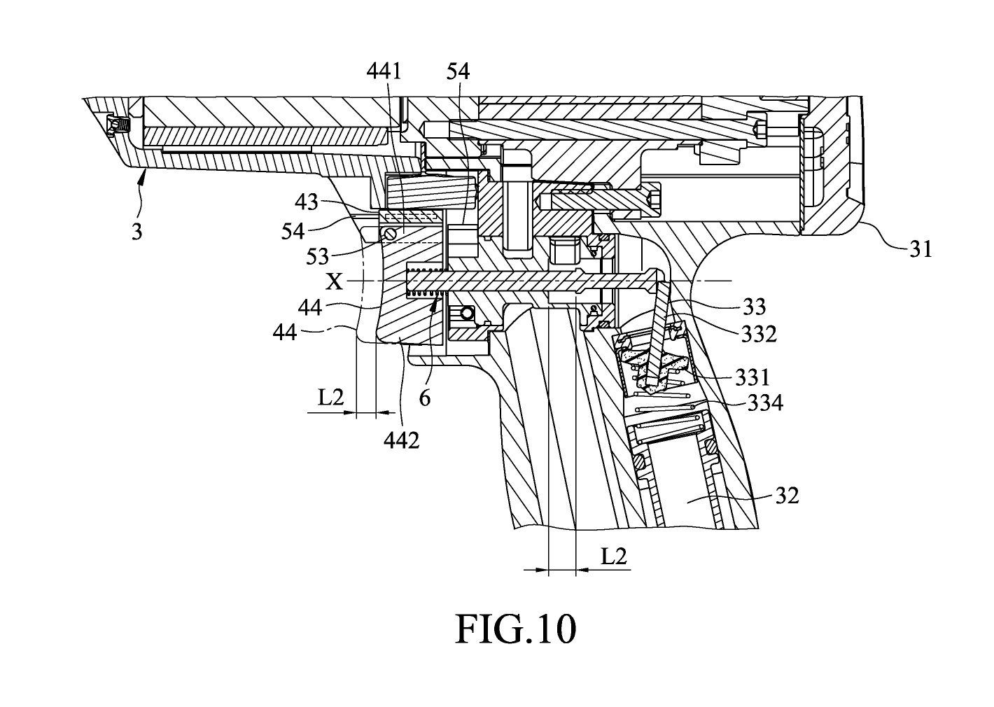

FIGS. 8, 9, and 10 show the second preferred embodiment of a pneumatic tool according to this invention, which is similar to the first preferred embodiment.

In this embodiment, the trigger 4 includes a first plate 43 and a second plate 44. The first plate 43 has two engaging portions 431 extending respectively from two opposite sides thereof away from each other, and a recess 432. The second plate 44 has a connecting portion 441 adjacent to an end thereof, and a swinging portion 442 adjacent to an opposite end thereof. The connecting portion 441 is configured as a projection, and engages rotatably the recess 432 of the first plate 43.

The motion conversion unit 5 includes a pin 53 and two aligned tracks 54. The pin 53 extends through the first plate 43 and the connecting portion 441 of the second plate for connecting the first and second plates 43, 44 pivotally to the body 31. The tracks 54 are configured as two slide slots formed in the body 3. The engaging portions 431 of the first plate 43 engage respectively and movably the tracks 54.

When no external force is applied, due to the biasing action of the first resilient member 334, the plug 331 seals the passage 32, the plug rod 332 is pressed against the rod member 333, and the second plate 44 projects outwardly from the body 31.

The second resilient member 6 is disposed between the body 31 and the swinging portion 442 of the second plate 44 to facilitate positioning of the second plate 44.

At the first stage, an external force is applied to the swinging portion 442 of the second plate 44 to overcome the biasing forces of the first and second resilient members 334, 6, so as to rotate the second plate 44 counterclockwise relative to the first plate 43 until the second plate 44 is blocked by an inner surface of the first plate 43 from further rotation relative to the first plate 43. As such, during the first stage, the trigger 4 rotates from the first position to the second position, and the second plate 44 pushes and moves the rod member 333 by the first distance (L1).

At the second stage, when application of the external force is continued, since further counterclockwise rotation of the second plate 44 relative to the first plate 43 is prevented, the first and second plates 43, 44 move along the tracks 54 to drive movement of the rod member 333 along the axis (X) by the second distance (L2).

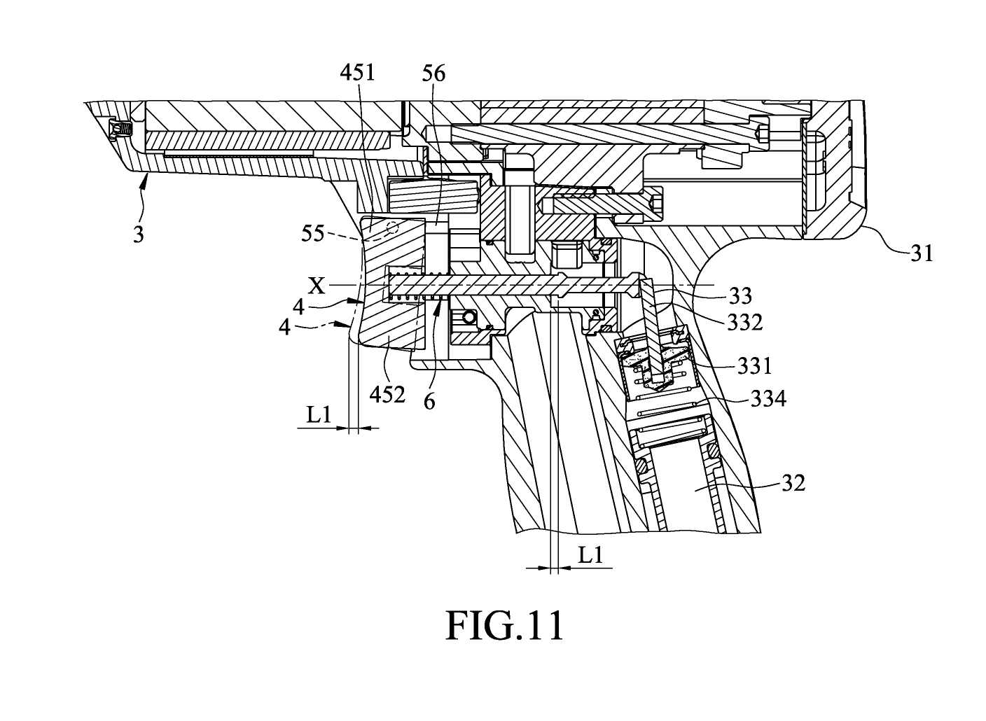

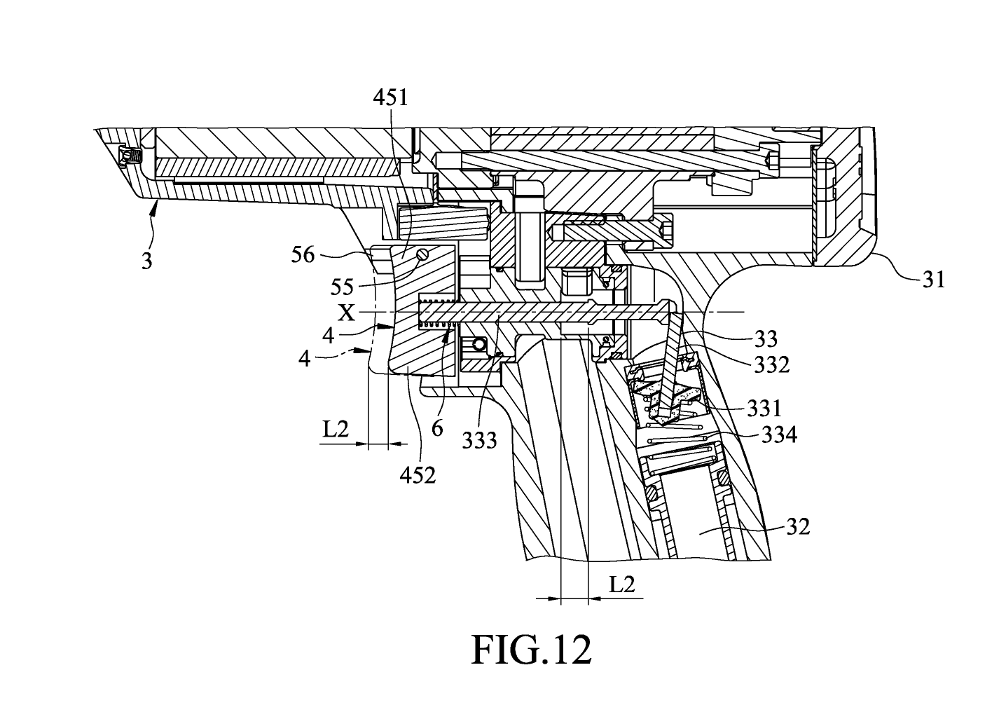

FIGS. 11 and 12 show the third preferred embodiment of a pneumatic tool according to this invention, which is similar to the first preferred embodiment.

In this embodiment, the trigger 4 is formed as one piece, and has a connecting portion 451 adjacent to an end thereof, and a swinging portion 452 adjacent to an opposite end thereof.

The motion conversion unit 5 includes two aligned pins and two aligned tracks 56. The pins 55 extend respectively from two opposite sides of the connecting portion 451 of the trigger 4 away from each other. The tracks 56 are formed in the body 31, and are configured as slide slots. The pins 55 are inserted respectively and movably into the tracks 56.

At the first stage, an external force is applied to the swinging portion 452 of the trigger 4 to overcome the biasing forces of the first and second resilient members 334, 6, so as to rotate the trigger 4 counterclockwise about the pin 55 from the first position to the second position until the swinging portion 452 of the trigger 4 comes into contact an inner surface of the body 31, thereby preventing further counterclockwise rotation of the trigger 4. Rotation of the trigger 4 from the first position to the second position results in movement of the rod member 333 along the axis (X) by the first distance (L1).

At the second stage, upon continued application of the external force to the trigger 4, the pins 55 move along the tracks 56, respectively, so that the trigger 4 pushes and moves the rod member 333 along the axis (X) by the second distance (L2).

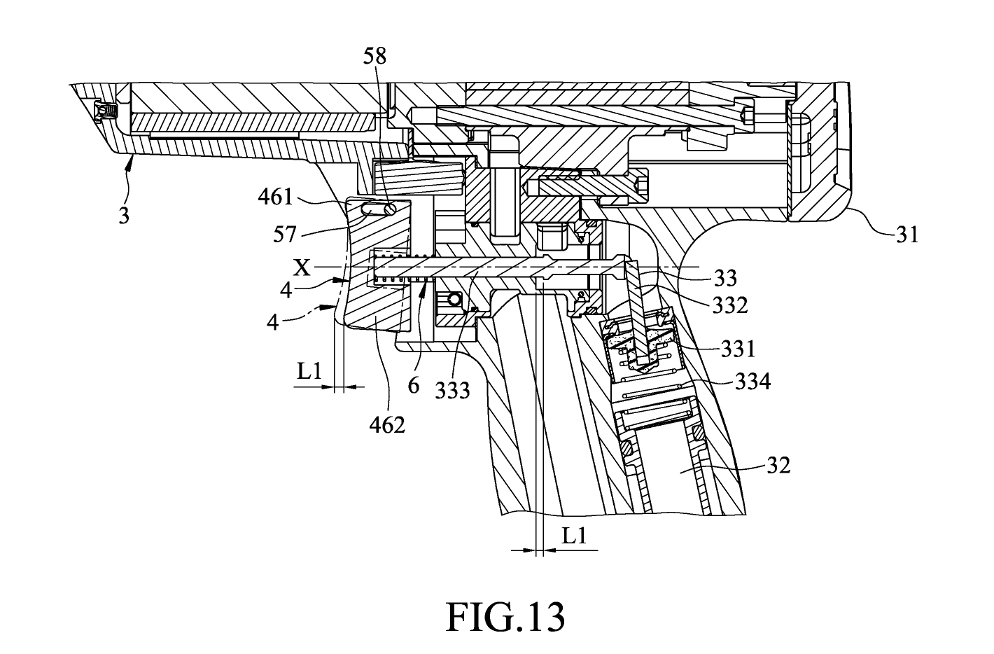

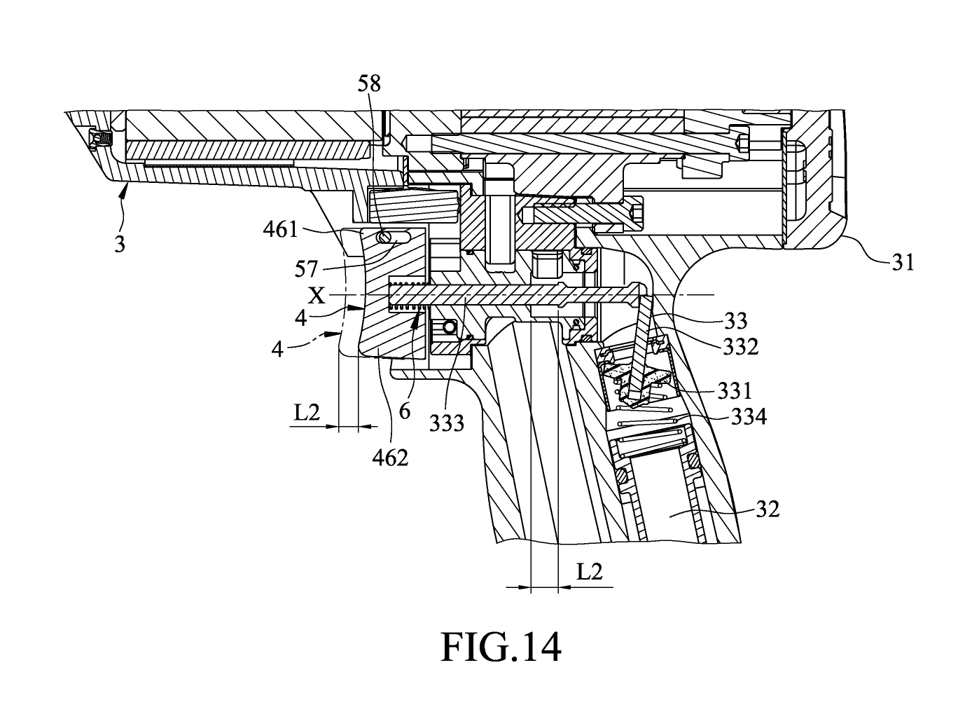

FIGS. 13 and 14 show the fourth preferred embodiment of a pneumatic tool according to this invention, which is similar to the third preferred embodiment.

In this embodiment, the trigger 4 has a connecting portion 461 adjacent to an end thereof, and a swinging portion 462 adjacent to an opposite end thereof.

The motion conversion unit 5 includes a track 57 and a pin 58. The track 57 is configured as a slide slot formed through the connecting portion 461 of the trigger 4, and has two closed ends. The pin 58 is connected fixedly to the body 31, and extends movably through the track 57.

Due to the biasing action of the second resilient member 6, the pin 58 is disposed in one end of the track 57.

At the first stage, an external force is applied to the swinging portion 462 of the trigger 4 to overcome the biasing forces of the first and second resilient members 334, 6, so as to rotate trigger 4 counterclockwise about the pin 58 until the trigger 5 comes into contact with an inner surface of the body 31, thereby moving the rod member 333 along the axis (X) by the first distance (L1).

At the second stage, since further counterclockwise rotation of the trigger 4 is prevented, when application of the external force is continued, the trigger 4 moves along the axis (X) until the pin 58 reaches the other end of the track 57, thereby moving the rod member 333 along the axis (X) by the second distance.

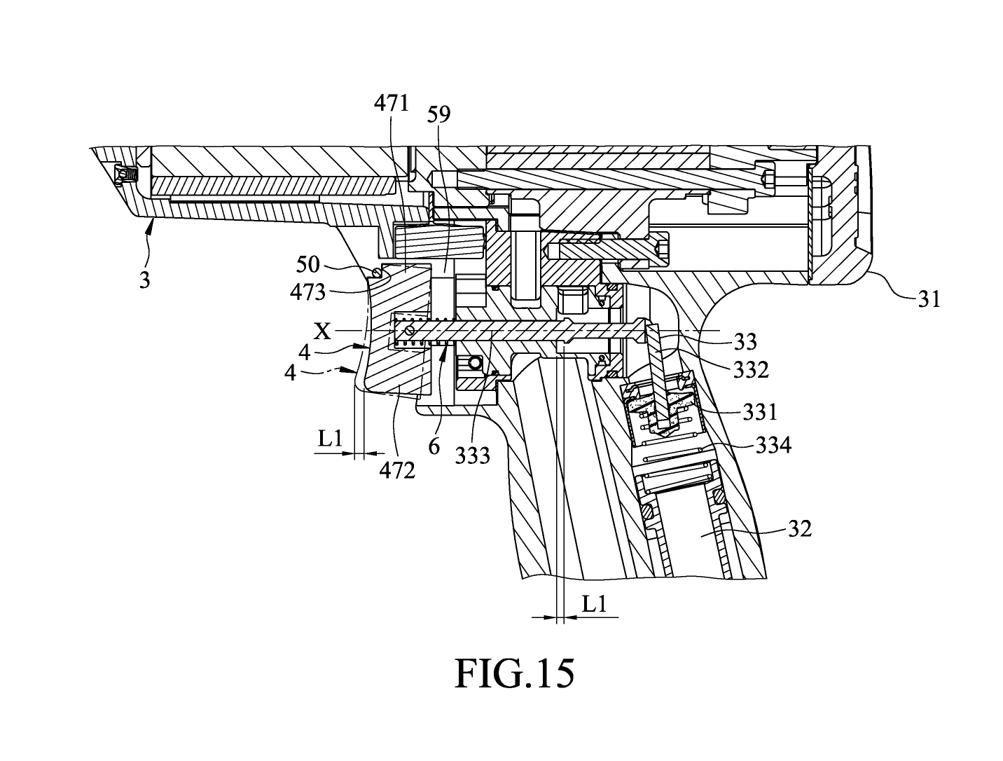

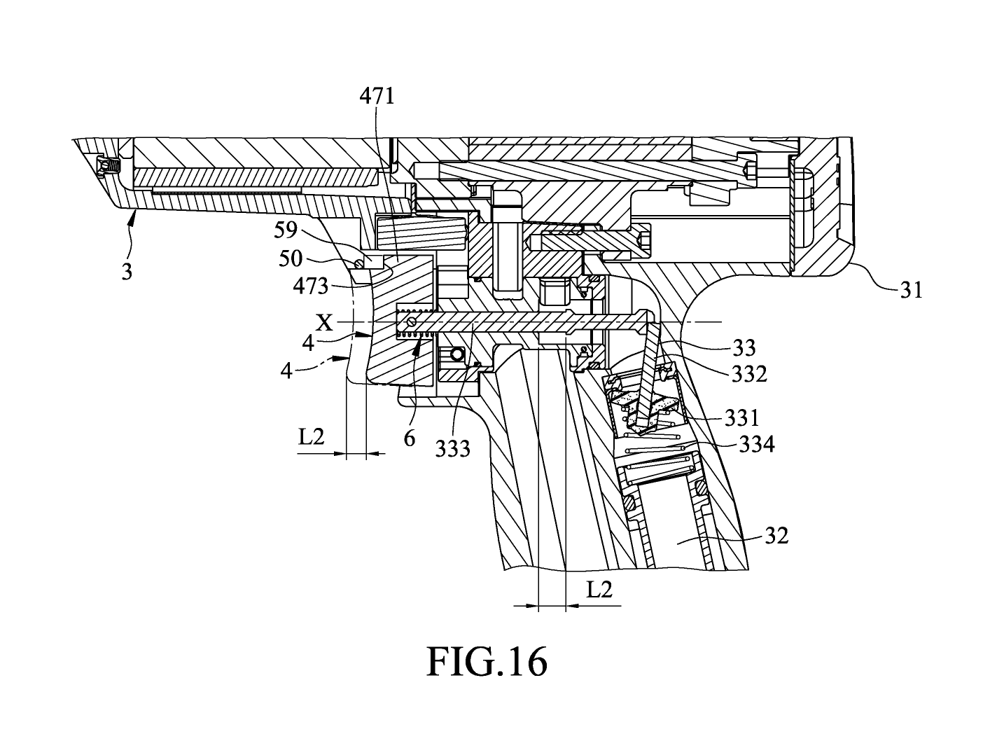

FIGS. 15 and 16 show the fifth preferred embodiment of a pneumatic tool according to this invention, which is similar to the third preferred embodiment.

In this embodiment, the trigger 4 has a connecting portion 471 adjacent to an end thereof, a swinging portion 472 adjacent to an opposite end thereof, and a notch 473 formed in a side of the connecting portion 471.

The motion conversion unit 5 includes a track 59 and a pin 50. The track 59 is formed in the body 31, and is configured as a slide slot. The connecting portion 471 of the trigger 4 engages movably the track 59. The pin 50 extends through the notch 473, is fixed in the body 31, and is in contact with a wall of the trigger 4 defining the notch 473.

At the first stage, an external force is applied to the swinging portion 472 of the trigger 4 to overcome the biasing forces of the first and second resilient members 334, 6, so as to rotate the swinging portion 472 of the trigger 4 counterclockwise about the pin 50 until the connecting portion 471 of the trigger 4 comes into contact with an inner surface of the body 31 parallel to the axis (X), thereby moving the rod member 333 by the first distance (L1).

At the second stage, upon continued application of the external force to the swinging portion 472 of the trigger 4, the trigger 4 moves along the axis (X) such that the connecting portion 471 of the trigger 4 moves along the track 59, thereby moving the rod member 333 along the axis (X) by the second distance (L2).

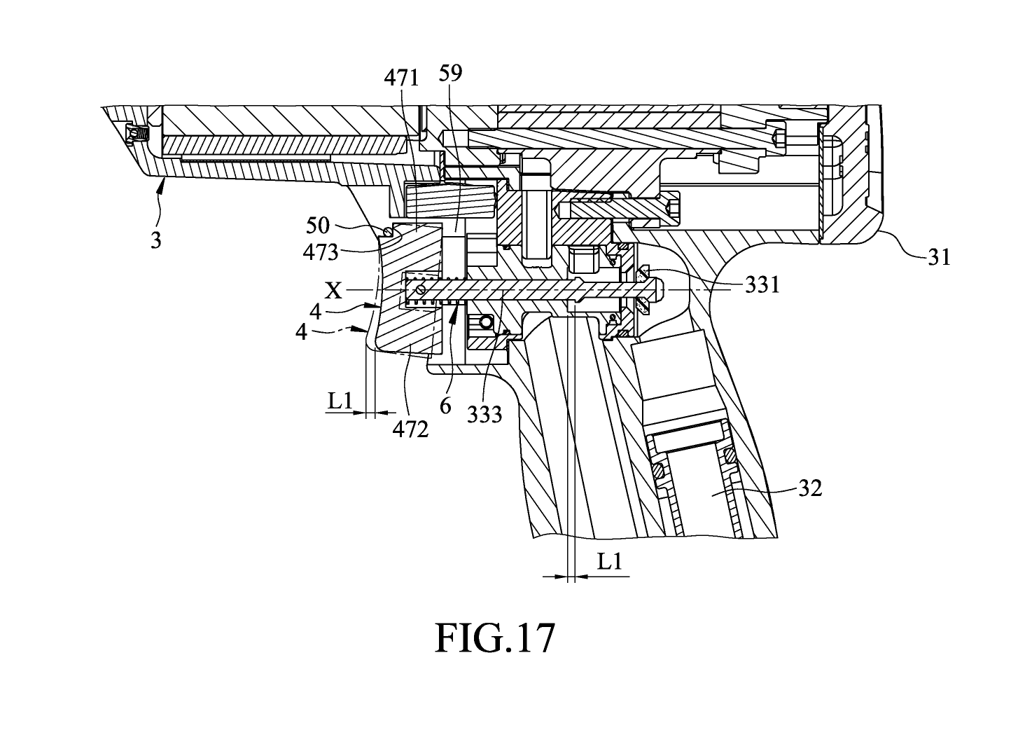

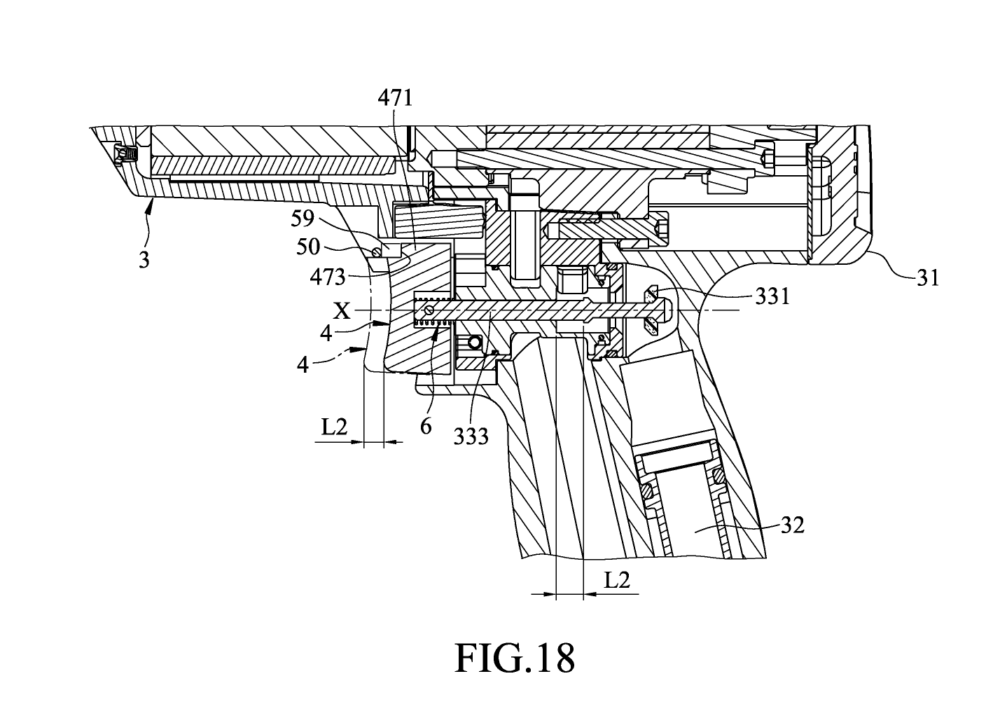

FIGS. 17 and 18 show the sixth preferred embodiment of a pneumatic tool according to this invention, whish is similar to the fifth preferred embodiment.

In this embodiment, the plug 331 is sleeved on the rod member 333. When not external force is applied, the plug 333 seals the passage 32. At the end of the first stage, the plug 331 is moved to a position whereat the passage 32 is opened to a predetermined degree. At the end of the second stage, the plug 331 is moved to another position whereat the passage 32 is opened to a greater degree.

In view of the above, the pneumatic tool of this invention has the following advantages.

Through conversion between the rotation of the trigger 4 and the linear movement of at least one portion of the trigger 4, the end of the first stage can be realized to facilitate easy and accurate control of the gas flow rate. Especially, at the second stage, since the motion of the at least one portion of the trigger 4 is linear movement, the gas flow rate at the second stage can be controlled more accurately. Furthermore, due to direct connection between the trigger 4 and the rod member 333, during operation of the trigger 4, it is only necessary to rotate the trigger 4 by a small angle. This can avoid the finger of user to be clamped between the trigger 4 and the body 31. Further, at the first stage, since the motion of the trigger 4 is rotation, a small external force applied to the trigger 4 is enough to overcome the biasing forces of the first and second resilient members 334, 6, so that the trigger 4 is easy to operate.

With this invention thus explained, it is apparent that numerous modifications and variations can be made without departing from the scope and spirit of this invention. It is therefore intended that this invention be limited only as indicated by the appended claims.

I claim:

1. A pneumatic tool comprising a body, a passage formed in the body and permitting flow of a gas therethrough, a plug for sealing said passage, a rod member movable along an axis so as to drive said plug to open said passage, and a two-stage trigger device, movement of said rod member in a direction increasing gradually the opening degree of said passage, said two-stage trigger device including:
a trigger connected to said rod member and rotatable relative to said body from a first position to a second position in response to initial application of an external force to said trigger, so as to move said rod member along the axis by a first distance;
wherein, when the trigger reaches the second position, and when application of the external force is continued, at least one portion of said trigger moves along the axis to drive movement of said rod member along the axis by a second distance.

2. The pneumatic tool as claimed in claim 1, further comprising a motion conversion unit that includes at least one pin for connecting said trigger pivotally to said body so that said trigger rotates about said pin in response to actuation of said trigger, and at least one track disposed at one of said body and said trigger, said at least one portion of said trigger engaging movably said track and being movable along said track after rotation of said trigger about said pin.

3. The pneumatic tool as claimed in claim 2, wherein said trigger has a connecting portion adjacent to an end thereof, and at least one swinging portion adjacent to an opposite end thereof, and said motion conversion unit includes two said pins extending respectively from two opposite sides of said connecting portion of said trigger away from each other, and two said tracks formed in said body and permitting said pins to be inserted respectively and movably thereinto, said rod member abutting against said swinging portion of said trigger, said trigger being rotatable about said pins.

4. The pneumatic tool as claimed in claim 2, wherein said track is configured as a slide slot parallel to the axis and formed through said connecting portion of said trigger, said pin extending movably through one end of said track and being connected fixedly to said body, said trigger being rotatable about said pin until said pin is moved to the other end of said track.

5. The pneumatic tool as claimed in claim 2, wherein said track is configured as a slide slot, and is formed in said body, said trigger being connected pivotally to said rod member, and having a connecting portion adjacent to an end thereof and engaging movably said track, and a swinging portion adjacent to an opposite end thereof, said pin being connected fixedly to said body and in contact with a side of said connecting portion.

6. The pneumatic tool as claimed in claim 5, wherein said connecting portion of said trigger is formed with a notch, said pin extending through said notch, being fixed in said body, and being in contact with a wall of said trigger defining said notch.

7. The pneumatic tool as claimed in claim 2, wherein said trigger includes a first plate and a second plate, said first plate being rotatable about said pin, said second plate being movable relative to said first plate along the axis and constituting said at least one portion of said trigger.

8. The pneumatic tool as claimed in claim 7, wherein said motion conversion unit includes two said tracks formed in said body and aligned with each other, said first plate having two engaging portions extending respectively from two opposite sides of said first plate away from each other and inserted respectively and movably into said tracks.

9. The pneumatic tool as claimed in claim 8, wherein said first plate has a recess, and said second plate has a projection engaging rotatably said recess.

10. The pneumatic tool as claimed in claim 7, wherein said first plate has a connecting portion adjacent to an end thereof, and two swinging portions adjacent to an opposite end thereof and spaced apart from each other, said pin extending through said connecting portion of said first plate for connecting said first plate pivotally to said body, said motion conversion unit including two said tracks disposed respectively on said swinging portions, said second plate engaging movably said tracks.

11. The pneumatic tool as claimed in claim 10, wherein said tracks are configured as two spaced-apart ribs extending respectively from said swinging portions toward each other, said second plate having a T-shaped projection defining two slide slots formed respectively in two opposite sides of said T-shaped projection, said ribs engaging respectively and movably said slide slots.

12. The pneumatic tool as claimed in claim 1, further comprising a first resilient member disposed between said body and said plug for biasing said plug to seal said passage.

13. The pneumatic tool as claimed in claim 12, further comprising a second resilient member disposed between said body and said trigger for biasing said trigger to project outwardly from said body.
